(19) United States
(12) Patent Application Publication
(10) Pub. No.: US 2024/0005430 A1
(43) Pub. Date: Jan. 4, 2024

(54) CONTEXTUAL TRAINING RECOMMENDATIONS

(71) Applicant: VMWARE, INC., Palo Alto, CA (US)

(72) Inventors: Rohit Pradeep SHETTY, Bangalore (IN); Ramani PANCHAPAKESAN, Bangalore (IN); Ravish CHAWLA, Atlanta, GA (US)

(21) Appl. No.: 17/895,142

(22) Filed: Aug. 25, 2022

(30) Foreign Application Priority Data
Jul. 2, 2022 (IN) 202241038204

(51) Int. Cl. G06Q 50/20; G06N 20/00

(52) U.S. Cl. CPC G06Q 50/2057; G06N 20/00

(57) ABSTRACT

Disclosed are various approaches for surfacing contextual training programs for users. In some examples, user context data is identified for a user account. The user context data is inputted into a training recommendation model. A training recommendation is generated. The training recommendation recommends a training program that is mapped to the user context data by the training recommendation model. The training recommendation or the training program is surfaced to a client device that is identified by the contextual training service.

### RELATED APPLICATIONS

Benefit is claimed under 35 U.S.C. 119(a)-(d) to Foreign Application Serial No. 202241038204 filed in India entitled “CONTEXTUAL TRAINING RECOMMENDATIONS”, on Jul. 2, 2022, by VMware, Inc., which is herein incorporated in its entirety by reference for all purposes.

### BACKGROUND

In an enterprise setting, individuals can utilize a number of different services and applications that are provided by an enterprise. One example is company-mandated or sponsored training programs for employees. These training programs are a part and parcel of employee life. In general, the training programs can cover the usual topics of security, ethical behavior, prevention of sexual harassment, re-skilling, and other topics. Traditionally, training programs are delivered annually, semi-annually, or otherwise on a fixed schedule based on the team an employee belongs to. However, fixed schedule training programs can be ineffective.

One solution to overcome this is to divide training programs into smaller snippets and providing more interactive content. However, even these changes have not had the desired effect. Training programs provided out of context and on a fixed schedule are often treated as lacking relevance and as a chore by employees.

The result is a lack of participation by employees, as well as the reluctant desire to quickly complete such training rather than having the desired effect on the employees' psyche. As a result, there is a need for more effective solutions for training employees with the appropriate skills and sensibilities of the workplace.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram depicting an example of a network environment according to examples of the disclosure.

FIG. 2 depicts a scenario according to examples of the disclosure.

FIG. 3 depicts a scenario according to examples of the disclosure.

FIG. 4 is a flow chart depicting the operation of an example of a component of the client device of the network environment of FIG. 1.

### DETAILED DESCRIPTION

Disclosed are examples of systems and methods for contextual training recommendations. In an environment in which training videos and other training programs such as audio training, interactive training, and other training programs are becoming more ubiquitous, providing users access to appropriate training programs at an appropriate time can be beneficial. Traditionally, training is performed on a fixed schedule based on the team an employee belongs to. However, fixed schedule training programs can be ineffective, and can result in a lack of participation by employees, as well as the reluctant desire to quickly complete such training rather than having the desired effect on the employees' psyche. The present disclosure describes contextual training recommendations that enable personalized training regimens based on event models and machine learning models. The machine learning models can build on manual recommendations, event model recommendations, previous machine learning recommendations, as well as user feedback and administrative feedback. This can enable more efficient use of devices used to view training programs as well as devices used to view and provide feedback and manual input.

Training programs, like any other aspect of learning are most effective when delivered at the right time. A training on diversity, security, coding practices, and other job skills delivered at the start of the year is most likely to be the last thing on the top of a user's mind in the middle or the end of the year. Thus, training programs or refresher courses are most effective when delivered with context. The present disclosure describes systems and methods for delivering training programs to employees based on context and corresponding triggers.

Enterprises can have access to employee generated data (email, location, device, etc.) and also through access to third party services. This employee generated data coupled with an employee's workplace information (job profile, designation, group, etc.) can be utilized to better predict an employee's training program needs. An artificial intelligence or machine learning engine can evaluate the various parameters making up an employee context, predefined event triggers, and feedback to come up with contextual training suggestions for employees. The feedback loop can be provided from the relevant employees and administrators or managers to fine-tune the predictions over a period of time.

Nonlimiting examples can include: surfacing, on a user's device, a training program on diversity when a member is joining a diverse team; surfacing a training program on security and local culture when an employee travels or is due to travel; surfacing a training on re-skilling based on high occurrence of defects on enterprise role-specific items such as code error types or programming language errors, and so on. The system can identify joining a diverse team, employee travel, role-specific issues, and so on, based on review comments, emails, workflows, tickets requested or received, and other user context information.

An event detection service can identify events that include or are associated with user context information. Since this information can in various situations originate from or be detected by a client device at a device layer or the contextual recommendation service at a cloud layer, fog layer, or another server layer, the event detection can be performed by executable components on both a client device and a computing environment of the contextual recommendation service.

These events can be based on the applications on the user's device, management changes that are detected on the user profile, and other updates. In some examples, event detection service can respond to code updates via a user's installed code-analysis tools, where the user role includes software development. Likewise, the event detection service can identify role-specific document updates including word processing documents, flowchart documents, email documents, and other documents for certain user context data such as workflow and other activity data.

The event detection service can work in tandem with content analysis services for the contextual recommendation service. The content analysis services can include a keyword analysis algorithm, which can take in raw text from triggered events to pull in meaningful keywords that will be fed to the recommendation models of the contextual recommendation service.

Training recommendations by the contextual recommendation service can be surfaced to the user's manager along with a justification or set of data that indicates why the training recommendation was generated. The manager can then greenlight or reject the training recommendation. On greenlighting a training recommendation, a manager can change the status to mandatory. This indicates that the employee will be required to complete the recommended training, rather than providing it as an option or recommendation.

Surfacing the recommendation to the manager can result in a number of changes such as adding additional training programs to the recommendation, adding additional users to the recommendation, changed manner of surfacing, and so on. The manager can also reject the training suggestions for the employee based on the circumstances. In such cases, the rejection itself, as well as any comments or textual or user-selected reason from a list of reasons can serve as a feedback loop for the machine learning model to improve.

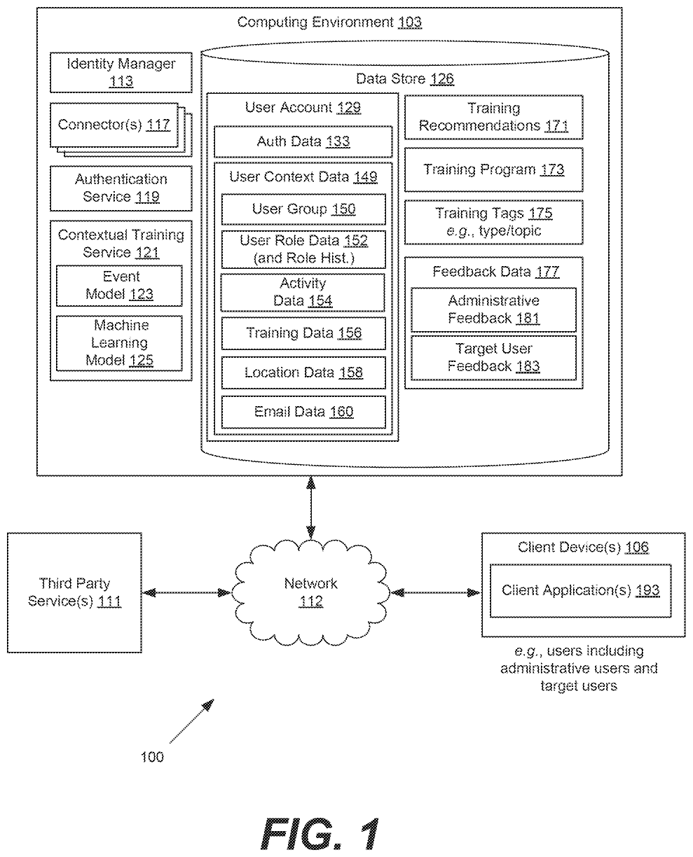

Beginning with FIG. 1, shown is an example of a networked environment 100. The networked environment 100 includes a computing environment 103, a client device 106, and one or more third party services 111, which are in data communication with each other across a network 112.

The network 112 includes wide area networks (WANs) and local area networks (LANs). These networks can include wired or wireless components or a combination thereof. Wired networks can include Ethernet networks, cable networks, fiber optic networks, and telephone networks, such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FI®), BLUETOOTH® networks, microwave transmission networks, as well as other networks relying on radio broadcasts. The network 112 can also include a combination of two or more networks 112. Examples of networks 112 can include the Internet, intranets, extranets, virtual private networks (VPNs), and similar networks.

The computing environment 103 can include, for example, a server computer or any other system providing computing capability. Alternatively, the computing environment 103 can employ a plurality of computing devices that can be arranged, for example, in one or more server banks or computer banks or other arrangements. These computing devices can be located in a single installation or can be distributed among many different geographical locations. For example, the computing environment 103 can include a plurality of computing devices that together can include a hosted computing resource, a grid computing resource, or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103 according to various examples. The components executed in the computing environment 103, for example, can include an identity manager 113, one or more connectors 117, an authentication service 119, and a contextual training service 121.

The contextual training service 121 can have multiple training recommendation models including an event model 123, as well as a machine learning model 125 in order to generate training recommendations 171. The contextual training service 121 can, in some examples, use multiple event models 123 and multiple machine learning models 125 concurrently. For the purposes of discussion, the contextual training service 121 can refer to cloud layer and other server layer executable instructions that work in concert to generate training recommendations 171.

An event model 123 can generally include rules that define a contextual set of triggers or trigger conditions that result in a training recommendation 171 for a particular user to interact with a particular training program 173 at a particular time. Interacting with the training program 173 can include watching, listening, clicking through, selecting answers within, and other interactions with the training program 173. The training program 173 can include one or more of an audio file, a video file, a textual file, an interactive or non-interactive training executable file. In other words, a training program 173 can include audiovisual, textual, and interactive elements.

The triggers defined within the event model 123 can use information identified from the user context data 149. Data for multiple different users can be used to identify training recommendations 171 for a single user. In other examples, data for a single user can be used to identify training recommendations 171 for a set of multiple users. Users can include employees, students, and other persons associated with an enterprise such as a company, school, or other organization. Triggers for an event model 123 can specify a predefined threshold for one or more datapoints of the user context data 149. The threshold can be defined as a frequency or count for each of one or more datapoints of the user context data 149.

The training programs 173 can include full training programs 173 and shortened training programs 173 on the same topic. The shortened training programs 173 can be shorter than full training programs 173 in one or more of completion time, number of questions, and so on. In some examples, an event model 123 can map a set of user context data 149 dynamically to both the full training program 173 and the shortened training program 173 on the same topic.

If a user account 129 includes training data 156 that indicates the user has gone through the full training program 173 within a threshold period of time, then the training recommendation 171 can recommend the shortened training program 173. Otherwise, if the user has not gone through the full training program 173 within the threshold period of time, then the training recommendation 171 can recommend the full training program 173.

A machine learning model 125 can be provided with inputs that include data from the user accounts 129 and user context data 149 in order to generate a training recommendation 171 for a particular user to interact with a particular training program 173 at a particular time. The machine learning model 125 can include a reinforcement learning based machine learning model that takes as input a sequence of training tags 175, and the user context data 149. Reinforcement learning can include game theory, control theory, operations research, information theory, simulation-based optimization, multi-agent systems, swarm intelligence, and other types of machine learning models 125. A machine learning model 125 can learn to map user context data 149 and training tags 175 to training recommendations 171 to maximize accuracy of the recommendations. The training tags 175 can include tags that describe or are associated with a particular training program 173.

The machine learning model 125 can discover which training recommendations 171 result in the most reward by trying them and learning based on the feedback data 177. The machine learning model 125 can take the training tags 175 and the user context data 149 as inputs to contextually generate or output a training recommendation 171 for a particular training program 173 for a particular user or user account 129. This can enable time and context specific recommendations based on updates and changes to this information as well as identified future changes indicated by the user context data 149.

Feedback data 177 can be provided as input to the machine learning model 125 to provide positive and negative feedback that can clarify whether the training recommendations 171 are correct or incorrect. The machine learning model 125 can be trained using feedback data 177 that indicates a training recommendation 171 as correct, incorrect, or administratively modified. Administrative modifications can include different types including making the training recommendation mandatory, expanding a training recommendation 171 from one user to multiple users, reducing a training recommendation 171 that is contracted from multiple users to fewer users, and so on. Where a training recommendation 171 is expanded, the user context data 149 for the user accounts 129 added by the expansion can be provided as input. Where a training recommendation 171 is contracted, the user context data 149 for the user accounts 129 removed by the contraction can be provided as input. The administrative modification decision itself, or the type of modification can be provided as an input.

The user context data 149 can include meta-data such as job title, role title and description, work history, and other stored information. For example, the user context data 149 can include a user group 150, user role data 152, activity data 154, training data 156, location data 158, and email data 160. Each of the items of user context data 149 can include both new datapoints and a history of datapoints for the data indicated.

As indicated above, the training programs 173 can include full training programs 173 and shortened training programs 173 on the same topic. While there is no static rule for when the machine learning model 125 must recommend a particular one of the full training programs 173 or the shortened training programs 173 on a topic, the user context data 149, including the training data 156, can be timestamped. As a result, the machine learning model 125 can learn to provide a full training program 173 in some instances and in other instances provide a shortened training program 173 in view of the recency of a user having completed a particular training program 173 or training program topic. Feedback data 177 can also be instrumental in determining whether a full training program 173 or shortened training program 173 should be recommended. For example, the feedback data 177 can indicate modification of a recommendation from a full training program 173 to a shortened training program 173 and vice versa.

The user group 150 can include a group such as users in a department, team, building, campus, or site including a group of buildings, branch of the organization that the user belongs to, and so on. Some users can belong to multiple user groups 150 and subgroups. The user group 150 data can also provide an identification or name for the group and any subgroups. For example, an organizational branch, a business unit or department, a team, and other subgroups can be indicated.

The user role data 152 can include a role title or job title, as well as a written description of the role and responsibilities. The user role data 152 can also include a listing of skills and primary skills of the particular employee. The user group 150 data and the user role data 152 can be considered a user profile. The user profile or another item of user context data 149 can also include diversity indicia such as a user's age, race, cultural origin, sex, gender identity, country, religion, and other information that a user can electively provide. In some examples the user group 150 can indicate whether the group is considered diverse on a particular type of diversity. The user group 150 can identify whether the members of the user group 150 include user accounts 129 that indicate one or more diversity indicia. The training recommendation models can use diversity indicia to recommend diversity based training programs 173.

The activity data 154 can include a history of workplace activity information such as a ticket history, a workflow history, and so on. The ticket history can include tickets requested by the user as well as tickets received and handled by the user through a ticketing service. Workflow actions can include a set of enterprise actions or responsibilities assigned to and handled by the user through a workflow service that defines enterprise tasks for the user. Many enterprises can use a ticketing tool, which can include a first party or third party service 111 relative to the computing environment 103, which can be utilized to resolve issues faced by an employee at the workplace.

Tickets include tickets submitted to third party services 111 including tickets to tackle routine issues faced by users with respect to responsibility questions, devices, location questions, navigation questions, social issues, management issues, and so on. Tickets can also be raised for various other purposes such as needing an HR letter for loans or monies for various purposes such as travel, procuring new devices, hosting bills, and so on. The training recommendation models can use activity data 154 to generate a training recommendation 171 for work skills training programs 173, diversity training programs 173, safety training programs 173, work-life balance training programs 173, teamwork training programs 173, delegation training programs 173, safety training programs 173, cybersecurity and other enterprise security training programs 173, time management training programs 173, stress management training programs 173, and others.

All of these data points serve as portions that individually or together can constitute a trigger for the event model 123, and can also be used as inputs for the machine learning model 125 of the contextual training service 121. Frequency of tickets, or frequency of keywords identified from the tickets or other activity data 154 can be used to surface relevant training programs 173. As a nonlimiting example, if a user raises tickets associated with device repair or another topic or keyword, then this information can be mapped to a particular training program 173 on that topic. In the case of the event model 123, frequency of tickets over time, or total number tickets of a particular type can be explicitly mapped to a particular training program 173 on a related topic.

The training data 156 can include information about training programs 173 undergone by the employee in the recent past within a threshold period of time. The training data 156 can include the triggers from an event model 123 and also can specify the user context data 149 relied on by the event model 123 or machine learning model 125.

The location data 158 can include a geographical location of a client device 106 associated with the user account 129 of a user. The location data 158 can also include a history of locations of the client device 106. The location data 158 can be identified using GPS, network connection, triangulation, and other methods. The training recommendation models can use location data 158 to identify training programs 173 for a current or predicted future location. For example, training recommendation models can use location data 158 to identify diversity training programs 173, travel safety training programs 173, location-specific training programs 173, and so on.

The email data 160 can include keywords and other data extracted from emails transmitted and received by the user account 129. This can include emails received by an email application of the client applications 193. In some examples, the email application or another client application 193 can identify predefined keywords and other data from emails transmitted and received by the user account 129. In some examples, email data 160 can be used to identify ticket identifiers, ticket topics and other activity data 154 communicated using email. Email can also be used to identify keywords that are associated with training tags 175.

The training recommendation models can use email data 160 to generate a training recommendation 171 for work skills training programs 173, diversity training programs 173, safety training programs 173, work-life balance training programs 173, teamwork training programs 173, delegation training programs 173, safety training programs 173, cybersecurity and other enterprise security training programs 173, time management training programs 173, stress management training programs 173, and others.

The email data 160 and activity data 154 can be used to identify and update other types of user context data 149 including updated locations, predicted future locations, and other location data 158; updated and predicted user groups 150; updated and predicted user role data 152, and so on.

The training tags 175 can include a dataset of information that associates one or more of the tags to a training program 173. The training tags 175 for training programs 173 can be used as inputs to the machine learning model 125 in order to map a user to a training program 173 at a particular time. Training tags 175 can be defined manually by administrators, data scientists, and other users. Training tags can also be defined automatically by a keywords analysis model or tagging model that extracts meaningful keywords and creates tags using a single keyword or a keyword phrase. The keyword analysis model can extract the keywords that are identified as meaningful from the training program 173 title, description, and script. Keywords analysis models can include sequence-to-sequence networks that can take as input a sequence of text and return a different sequence of text of smaller length.

The script can refer to a subtitle track of a video, machine-identified words based on audio, video, image, and text from the training program 173. This can include opening the training program 173 and identifying keywords by analysis of the resulting audio, video, image, and text whether the training program is or includes an audio file, video file, document file, or interactive executable. In some examples, the keywords analysis model or a program that uses the keywords analysis model can retrieve and analyze the training programs 173 from an Application (API) or otherwise from a third party service 111.

The feedback data 177 can include administrative feedback 181 and target user feedback data 183. The administrative feedback 181 can indicate whether an administrator or manager for the enterprise or the user approves, disapproves, makes mandatory, or modifies a training recommendation 171. To this end, the contextual training service 121 can surface the training recommendation 171, all or a subset of the user context data 149 and other data relied on, and an identification of the user or user account 129 to an administrative user. This can be performed before the recommended training program 173 is surfaced to the target user.

The contextual training service 121 can surface the training recommendation 171, the training program 173, and related descriptive information to a client device 106. For example, the contextual training service 121 can surface these items through a notification through a client application 193 of the administrative user, through a web-based console user interface that the user accesses using the client device 106, through an interface of a third party service 111 that the user accesses using the client device 106, or otherwise surface the training recommendation 171. If the administrator or manager disapproves the training recommendation 171, then the training program 173 is not surfaced to the target user.

In some examples, training recommendations 171 from the machine learning model 125 are surfaced to the administrative user, while training recommendations 171 from the event model 123 are not. In other examples, all training recommendations 171 are surfaced to the administrative user.

The target user feedback data 183 can include a completion status for the training program 173 recommended by the training recommendation 171. In some examples the completion status can be binary, indicating whether the training program 173 is “completed” or “not completed.” In other examples, the completion status can indicate a percentage of the training program 173 that is completed. For some interactive training programs 173, percentages of questions answered correctly and incorrectly can be indicated in the completion status.

In some examples, one or more third party services 111 can also be executed in the computing environment 103 in the case of service endpoints that are provided by the enterprise on the same computing resources of the enterprise. In some embodiments, however, one or more of the third party services 111 can be executed in a separate computing environment that is in communication with the computing environment 103 across the network 112.

Also, various data is stored in a data store 126 that is accessible to the computing environment 103. The data store 126 can be representative of a plurality of data stores, which can include relational databases, object-oriented databases, hierarchical databases, hash tables or similar key-value data stores, as well as other data storage applications or data structures. The data stored in the data store 126 is associated with the operation of the identity manager 113, the connector(s) 117, the authentication service 119, the contextual training service 121, and one or more of the third party services 111, as well as potentially other applications or functional entities described later. This data can include one or more user accounts 129 and potentially other data.

The identity manager 113 can authenticate users and manage user authorizations or permissions to access applications, data, or other computing resources. For example, the identity manager 113 can correspond to a single sign-on portal that verifies a user's authentication data 133, which can include authentication credentials, a single sign-on token that identifies the user, and verifies whether the user has the appropriate access and permissions to access one or more third party services 111, which can include services which can provide user access to the training program 173. Examples of identity managers 113 include VMWARE's Identity Manager, Workspace ONE®, or MICROSOFT's Active Directory Federation Services.

The authentication service 119 can retrieve and cache authentication data, such as authentication tokens and refresh tokens, provided by various third party services 111. The cached authentication data can be used by the assistant connection service 116 to query the third party services 111 for information.

A connector 117 can provide a standardized mechanism for the assistant connection service 116 to communicate with a third party service 111. Each third party service 111 may provide an application programming interface (API) for communicating, querying, or otherwise interacting with the third party service 111, which can include different methods or functions with different parameters compared to other third party services 111. This can allow for the assistant connection service 116 to send a single, uniformly formatted query to one or more connectors 117. Each connector 117 is then responsible for using the information provided in the query from the assistant connection service 116 to invoke the appropriate functions provided by the API of the third party service 111. To add support for a new third party service 111, a new connector 117 can be created without needing to modify the assistant connection service 116 itself. Likewise, if a change is made to the API of the third party service 111, the connector 117 between the assistant connection service 116 and the federated service can be updated without having to modify the assistant connection service 116 itself.

A third party service 111 can be web application, web service, or other network facing application that can be accessed using a shared identity manager 113. One or more third party services 111 can be provided by the same provider or by different providers. A third party service 111 can federate its authentication to the identity manager 113, which can authenticate a user and provide an authentication token that validates the user's identity within the identity manager 113.

The user account 129 represents information associated with a user. The information can include authentication data 133. The authentication data 133 can include one or more authentication credentials, one or more single sign-on tokens, and/or one or more access permissions applied to the user account, as well as cached authentication tokens and refresh tokens.

The authentication credentials represent the credentials that a user can present to the identity manager 113 to authenticate the user's identity. Authentication credentials can include a combination of a username and password, a cryptographic certificate, a one-time password, or a combination of several of authentication credentials as part of a multi-factor authentication schema. Examples of one-time passwords can include a one-time password generated using a version of the time-based one-time password algorithm (TOTP) or a one-time password generated using the HMAC-based one-time password (HOTP) algorithm.

A single sign-on (SSO) token is a software token generated by the identity manager 113 in response to a successful authentication of the user with the identity manager 113 using the authentication credentials. The SSO token can be used to provide a client device 106 access to various third party services 111 on behalf of the authenticated user. Additionally, the SSO token can be used by the assistant connection service 116 to access various third party services 111 on behalf of the authenticated user and a voice assistant device 107 associated with the user. In some instances, such as those implementing a version of the KERBEROS protocol, a separate SSO token can be generated for each third party service 111 that the client device 106 attempts to access on behalf of the user. In other instances, the single SSO token can be generated and used to provide the client device 106 with access to several of the third party services 111. Although each of the third party services 111 can have a different set of authentication credentials linked to the user account 129, such as a different username and password combination, the SSO token allows the user to authenticate once with the identity manager 113 in order to use each of the third party services 111 instead of having to authenticate with each of the third party services 111 separately.

The access permissions represent computing resources that the user account is authorized to access. For example, the access permissions can indicate that a user account is permitted to access some third party services 111 but is prohibited from accessing other third party services 111. As another example, the access permissions can indicate that the user account 129 can access certain features of a third party service 111 but prohibited from accessing other features. For example, if one of the third party services 111 that a user was permitted to access was a customer relationship management (CRM) service, the user might have permission to access his or her own contacts but be prohibited from accessing the sales contacts of other users. In some implementations, the access permissions can be defined at a user group level rather than at a user level in a directory service.

An authentication token is a token provided by the identity manager 113 or the third party service 111 in response to a successful authentication of the user. The authentication token represents that a user account 129 is currently authenticated to access a third party service 111 and authorized to access or otherwise interact with the third party service 111 in some capacity. For security purposes, the authentication token often has a time-limit associated with it, (such as 1 hour, 3 hours, 6 hours, 8 hours, or some other period of time). Once the time-limit has expired, the authentication token can no longer be used to prove current authentication status of the user account 129 with the third party service 111. The authentication token can be provided, for example, as part of an authentication exchange using a version of the OAUTH protocol.

A refresh token is a token provided by one of the third party services 111 in response to a successful authentication with the third party service 111. The refresh token can be used to acquire a new authentication token once a current or previous authentication token expires. The refresh token often has a much longer time-limit associated with it, such as 1 day, 1 week, 30 days, 3 months, or 1 year, which allows for the refresh token to be used to acquire a series of authentication tokens after an initial successful authentication. In the event that a user's access is revoked, the refresh token can be marked invalid, preventing the refresh token from being used to acquire new authentication tokens. The refresh token can be provided, for example, as part of an authentication exchange using a version of the OAUTH protocol.

Each third party service 111 can be associated with a federated user account. A user with a user account 129 may also have multiple federated user accounts. For example, a user may have one federated user account for each third party service 111 that the user is registered or enrolled with. As another example, the user may have multiple federated user accounts for a third party service 111 (e.g., a personal federated user account and a separate federated user account for business or professional purposes). The federated user account can be associated with an SSO token and an authentication token.

The client device 106 is representative of a plurality of client devices 106 that can be coupled to the network 112. The client device 106 can include, for example, a processor-based system such as a computer system. Examples of these computer systems can include a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), or other devices with like capability. The client device 106 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 106 or can be connected to the client device 106 through a wired or wireless connection.

The client device 106 can be configured to execute various applications such as one or more client applications 193. A client application 193 can cause a user interface to be rendered on the display. The client application 193 can represent various types of applications executable by the client device 106. In some examples, the client applications 193 can include client side training service executables and other applications that work in concert with the contextual training service 121. The client application 193 could be a web browser and the user interface could include a web page rendered within a browser window. As another example, a client application 193 can be an email application and the user interface could represent a graphical user interface for viewing, editing, and composing emails.

Additionally, the client application 193 can represent an application that facilitates user authentication with the authentication service 119 so that a user can create an association between a client device 106 and a user account 129. The client application 193 can also facilitate a single sign on service in concert with the components of the computing environment 103. The single sign on service can enable one or more of the client applications 193 to communicate with third party services 111 as well as first party services executed by the computing environment 103. For example, these first and third party network services can include ticket services, workflow services, device management services, enterprise content services, email services, training program hosting services, and so on.

The third party service 111 to which a third party service application 161 corresponds can require some form of user authentication before providing the third party service application 161 with user-specific data or information. For example, the third party service 111 might be a salesforce tool pr ticketing tool that contains highly sensitive user and enterprise data. Accordingly, a client application 193 can include a management application that is communicatively linked to, and works in concert with, the contextual training service 121. The client application 193 can also authenticate a user's access to the third party service 111. Additionally, the client application 193 can also permit SSO according to examples of this disclosure. In this way, once a user has associated the third party service 111 and other services with his or her user account 129 by authenticating with the identity manager 113, the identity manager 113 can also allow the user to access third party services 111 that have federated their authentication to the identity manager 113.

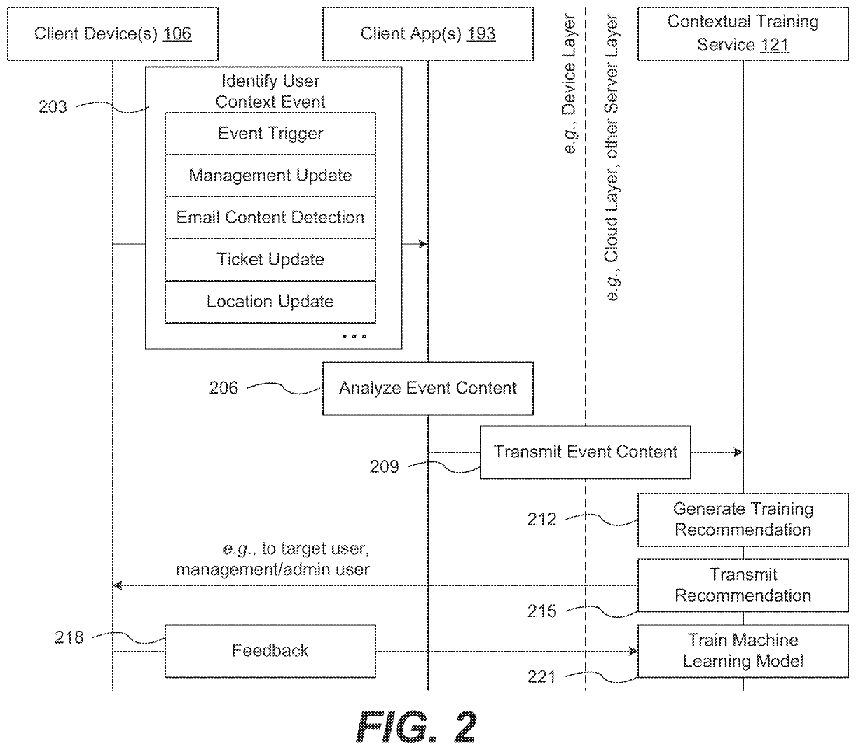

Referring next to FIG. 2, shown is a scenario that illustrates how interactions between the components of the networked environment 100 of FIG. 1 can operate. Generally, this example shows how device layer data can be provided to the contextual training service 121. The contextual training service 121 can then generate a training recommendation 171 and surface it to an administrative user such as a manager, as well as surface the training program 173 to a target user, identify feedback data 177, and train the machine learning model 125.

In step 203, the client application 193 can identify a user context event. The client application 153 can include a client side application such as an event identification service that works in concert with the contextual training service 121. The contextual training service 121 can transmit, to the client application 193, a list of user context events and instructions to identify the user context events. For example, the client application 193 can identify the presence of certain files and applications stored or executed by the client device 106. The client application 193 can identify the access of certain websites and third party services 111. The client application 193 can transmit these events from a device layer associated with the client device 106 to the contextual training service 121. The contextual training service 121 can be in a cloud layer of the computing environment 103.

The user context events can include identification of certain event triggers on a client device 106. Event triggers can include triggers that are defined in the event model 123 and linked to a particular training program 173. Event triggers can correspond to any of the types of user context data 149 described, which are mapped to a particular training program 173 by the event model 123. Generally, the client application 193 can also identify any other user context data 149 that is generated, received, transmitted, or otherwise identified on the client device 106.

The client application 193 can identify activity data 154 such as ticket requests transmitted to a network service such as a third party service 111 and workflows completed; training data 156 including accessing, progressing through, and completing a training program 173; location data 158 including identification of local area networks, GPS, and other location data; email data 160 such as drafting, receiving, and transmitting emails. In the various examples, any of the user context data 149 can be identified using the client application 193.

In step 206, the client application 193 can analyze the event content from the user context events and the user context data 149 that is identified. In order to reduce data transmitted, increase efficiency, and reduce load on the network 112 and the contextual training service 121, the client application 194 can identify the relevant event content. This can include identification of keywords in email data 160 and other activity data 154 rather than a wholesale transmission of the ticket, email, and other files and events. In other words, the client application 194 can include a list of identifiers for and keywords associated with the various types of user context data 149. This can both decrease network load and increase privacy and security. For example, the client application 193 can parse an email to identify a character string that is presented in a format of a ticket number for a ticket, a string associated with a type of ticket, a keyword associated with an item of user context data 149, and so on. In some cases, the item of user context data 149 is transmitted without transmitting any personally identifiable information. While the contextual training service 121 can use personally identifiable information from the user context data 149, this is identified at the server layer and is not transmitted.

In step 209, the client application 193 can transmit event content to the contextual training service 121. The event content can include a time stamp, a user account 129 identifier, and the item of user context data 149. The contextual training service 121 can store the user context data 149 and provide it as a real-time input to the event model 123 and the machine learning model 125. Since the inputs are provided in real time, meaning as soon as identified and received, the contextual training service 121 can provide time-specific training recommendations 171.

In step 212, the contextual training service 121 can generate a training recommendation 171. The training recommendation 171 can specify a recommended training program 173 for a particular user account 129. The contextual training service 121 can use the event model 123 and the machine learning model 125 in order to make the training recommendation 171. In some examples, the contextual training service 121 can specify a recommended time or time window within which the training program 173 should be surfaced to a user through an associated client device 106.

In step 215, the contextual training service 121 can transmit the training recommendation 171 to a client device 106. For example, the contextual training service 121 can identify a manager or other administrator responsible for management of the user or user account 129 specified in the training recommendation 171. The contextual training service 121 can then surface the training recommendation 171 to the administrative user for approval. This can also be referred to as surfacing the training program 173 to the administrator for approval, since the identity or identifier of the training program 173 is surfaced and in some cases, a link or access to the training program 173 itself can be provided as well. Alternatively, the contextual training service 121 can surface the training program 173 to the target user. For example, some event triggers for the event model 123 can be pre-approved for surfacing to target users immediately or according to a time or time window specified by the training recommendation 171.

In step 218, the contextual training service 121 can receive feedback data 177 from the client device 106. The feedback data 177 can include administrative feedback 181 and target user feedback data 183. The administrative feedback 181 can indicate whether an administrator or manager for the enterprise or the user approves, disapproves, makes mandatory, or modifies a training recommendation 171. In some examples, the administrative feedback 181 can be a prerequisite for surfacing the training program 173 to the target user. The target user feedback data 183 can include a completion status for the training program 173 recommended by the training recommendation 171.

In step 221, the contextual training service 121 can train the machine learning model 125 using the feedback data 177. Feedback data 177 can be provided as input to the machine learning model 125 to provide positive and negative feedback that can clarify whether the training recommendations 171 are correct or incorrect.

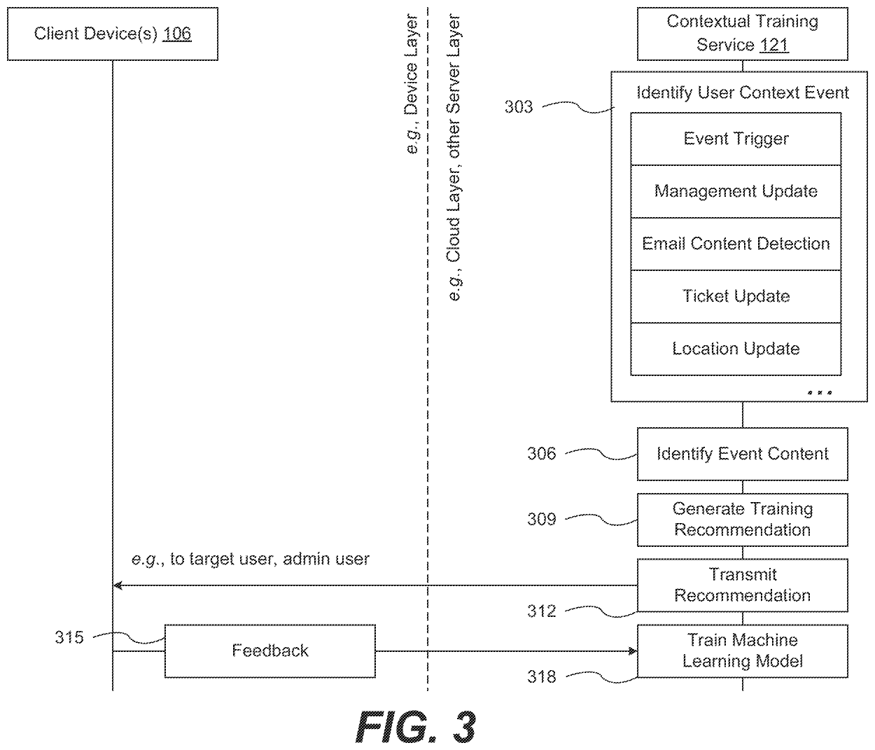

Referring next to FIG. 3, shown is a scenario that illustrates how interactions between the components of the networked environment 100 of FIG. 1 can operate. Generally, this example shows how cloud layer data can be provided to the contextual training service 121. The contextual training service 121 can then generate a training recommendation 171 and surface it to an administrative user such as a manager, as well as surface the training program 173 to a target user, identify feedback data 177, and train the machine learning model 125.

In step 303, the contextual training service 121 can identify a user context event. The contextual training service 121 can include a cloud or other server layer instructions such as a server layer event identification service. The contextual training service 121 can store a list of user context events and instructions to identify the user context events. The contextual training service 121 can identify user group 150 changes or updates, user role data 152 updates, activity data 154 updates, training data 156 updates, and any of the user context data 149 that is identifiable at the cloud layer. This can include monitoring updates applied through a console user interface that identifies a role update, a user group 150 update, and other user context data 149. The user context data 149 can correspond to event triggers or portions of event triggers defined in the event model 123 and linked to a particular training program 173. Generally, the contextual training service 121 can also identify any other user context data 149 that is generated, received, transmitted, or otherwise identified on the client device 106.

In step 306, the contextual training service 121 can identify the event content from the user context events and the user context data 149 that is identified. This can include identification of keywords in email data 160, activity data 154, and other received or generated at the server layer. In other words, the contextual training service 121 can include a list of identifiers for and keywords associated with the various types of user context data 149. The contextual training service 121 can store each item of user context data 149 in association with a time stamp and a user account 129 identifier. The contextual training service 121 can both store the user context data 149 and provide it as a real-time input to the event model 123 and the machine learning model 125. Since the inputs are provided in real time, meaning as soon as identified and received, the contextual training service 121 can provide time-specific training recommendations 171.

In step 309, the contextual training service 121 can generate a training recommendation 171. The training recommendation 171 can specify a recommended training program 173 for a particular user account 129. The contextual training service 121 can use the event model 123 and the machine learning model 125 in order to make the training recommendation 171. In some examples, the contextual training service 121 can specify a recommended time or time window within which the training program 173 should be surfaced to a user through the associated client device 106.

In step 312, the contextual training service 121 can transmit the training recommendation 171 to a client device 106. For example, the contextual training service 121 can identify a manager or other administrator responsible for management of the user or user account 129 specified in the training recommendation 171. The contextual training service 121 can then surface the training recommendation 171 to the administrative user for approval. This can also be referred to as surfacing the training program 173 to the administrator for approval, since the identity or identifier of the training program 173 is surfaced and in some cases, a link or access to the training program 173 itself can be provided as well. Alternatively, the contextual training service 121 can surface the training program 173 to the target user. For example, some event triggers for the event model 123 can be pre-approved for surfacing to target users immediately or according to a time or time window specified by the training recommendation 171.

In step 315, the contextual training service 121 can receive feedback data 177 from the client device 106. The feedback data 177 can include administrative feedback 181 and target user feedback data 183. The administrative feedback 181 can indicate whether an administrator or manager for the enterprise or the user approves, disapproves, makes mandatory, or modifies a training recommendation 171. In some examples, the administrative feedback 181 can be a prerequisite for surfacing the training program 173 to the target user. The target user feedback data 183 can include a completion status for the training program 173 recommended by the training recommendation 171.

In step 318, the contextual training service 121 can train the machine learning model 125 using the feedback data 177. Feedback data 177 can be provided as input to the machine learning model 125 to provide positive and negative feedback that can clarify whether the training recommendations 171 are correct or incorrect.

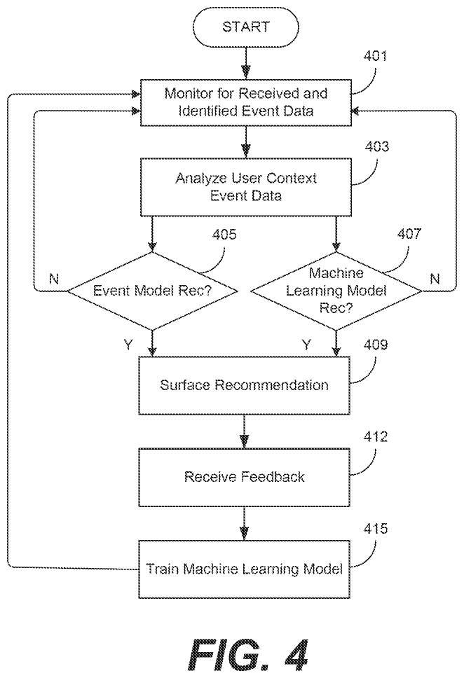

FIG. 4 is a flowchart depicting an example of the operation of a portion of the contextual training service 121 and potentially other applications or services shown in FIG. 1. As an alternative, the flowchart of FIG. 4 can be viewed as depicting an example of elements of a computer implemented method.

In step 401, the contextual training service 121 can identify user context event data. This can include user context event data that is originated at the server layer. The contextual training service 121 can identify user group 150 changes or updates, user role data 152 updates, activity data 154 updates, training data 156 updates, and any of the user context data 149 that is identifiable at the cloud layer. This can include monitoring updates applied through a console user interface that identifies a role update, a user group 150 update, and other user context data 149. These items can be stored as timestamped events within the user context data 149. Identifying user context event data can also include receiving user context event data as timestamped user context data 149 that originated from the device layer.

In step 403, the contextual training service 121 can analyze the user context event data. For example, the contextual training service 121 can provide the timestamped user context data 149 to the event model 123 and the machine learning model 125. The event model 123 can analyze the user context data 149 according to predetermined rules that map one or more items of user context data 149 individually or collectively to a training recommendation 171 for a particular training program 173. The machine learning model 125 can take the new user context data 149 as inputs, along with the previous user context data 149, feedback data 177, training recommendations 171, and other items discussed.

In step 405, the contextual training service 121 can determine whether the event model 123 has generated a training recommendation 171. For example, the event model 123 of the contextual training service 121 can identify that a set of user context data 149 constitutes an event trigger associated with a training recommendation 171 for a particular training program 173. If the event model 123 has generated a training recommendation 171, the process can move to step 409, otherwise, the process can move to step 401.

In step 407, the contextual training service 121 can determine whether the machine learning model 125 has generated a training recommendation 171. For example, the machine learning model 125 of the contextual training service 121 can take the new user context data 149 as inputs, along with the previous user context data 149, previous feedback data 177, previous training recommendations 171, and other items, and can map these inputs to output a training recommendation 171. If the machine learning model 125 has generated a training recommendation 171, the process can move to step 409, otherwise, the process can move to step 401.

In step 409, the contextual training service 121 can surface the training recommendation 171. For example, the contextual training service 121 can identify a manager or other administrator responsible for management of the user or user account 129 specified in the training recommendation 171. The contextual training service 121 can then surface the training recommendation 171 to the administrative user for approval. This can also be referred to as surfacing the training program 173 to the administrator for approval, since the identity or identifier of the training program 173 is surfaced and in some cases, a link or access to the training program 173 itself can be provided as well. Alternatively, the contextual training service 121 can surface the training program 173 to the target user. For example, some event triggers for the event model 123 can be pre-approved for surfacing to target users immediately or according to a time or time window specified by the training recommendation 171.

In step 412, the contextual training service 121 can receive feedback data 177 from the client device 106. The feedback data 177 can include administrative feedback 181 and target user feedback data 183. The administrative feedback 181 can indicate whether an administrator or manager for the enterprise or the user approves, disapproves, makes mandatory, or modifies a training recommendation 171. In some examples, the administrative feedback 181 can be a prerequisite for surfacing the training program 173 to the target user. The target user feedback data 183 can include a completion status for the training program 173 recommended by the training recommendation 171.

In step 415, the contextual training service 121 can train the machine learning model 125 using the feedback data 177. Feedback data 177 can be provided as input to the machine learning model 125 to provide positive and negative feedback that can clarify whether the training recommendations 171 are correct or incorrect.

The flowcharts and figures include examples of the functionality and operation of implementations of components described herein. The components described herein can include hardware, software, or a combination of hardware and software. If embodied in software, each element can represent a module of code or a portion of code that includes program instructions to implement the specified logical function(s). The program instructions can be embodied in the form of source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although the flowcharts and figures can show a specific order of execution, it is understood that the order of execution can differ from that which is shown. The order of execution of two or more elements can be switched relative to the order shown. Also, two or more elements shown in succession can be executed concurrently or with partial concurrence. Further, in some examples, one or more of the elements shown in the flowcharts can be skipped or omitted. In addition, any number of counters, state variables, warning semaphores, or messages could be added to the logical flow described herein, for purposes of enhanced utility, accounting, performance measurement, or troubleshooting aid. It is understood that all variations are within the scope of the present disclosure.

The components described herein can each include at least one processing circuit. The processing circuit can include one or more processors and one or more storage devices that are coupled to a local interface. The local interface can include a data bus with an accompanying address/control bus or any other suitable bus structure. The one or more storage devices for a processing circuit can store data or components that are executable by the one or processors of the processing circuit.

The components described herein can be embodied in the form of hardware, as software components that are executable by hardware, or as a combination of software and hardware. If embodied as hardware, the components described herein can be implemented as a circuit or state machine that employs any suitable hardware technology. This hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that includes software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as magnetic, optical, semiconductor, or other suitable media. Examples of a suitable computer-readable media include, but are not limited to, solid-state drives, magnetic drives, and flash memory. Further, any logic or component described herein can be implemented and structured in a variety of ways. One or more components described can be implemented as modules or components of a single application. Further, one or more components described herein can be executed in one computing device or by using multiple computing devices.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All modifications and variations are intended to be included herein within the scope of this disclosure.

What is claimed is:

1. A non-transitory computer-readable medium comprising machine-readable instructions, wherein the instructions, when executed by at least one processor, cause at least one computing device to at least:
identify, by a contextual training service, user context data for a user account, the user context data comprising identifications of: a user group, a user role, and at least one of: an activity history, a training history, a location history, and an email history;
input, by the contextual training service, the user context data into at least one training recommendation model;
generate, by the contextual training service, a training recommendation that recommends a training program that is mapped to the user context data by the at least one training recommendation model; and
surface, to a client device identified by the contextual training service, the training recommendation or the training program.

2. The non-transitory computer-readable medium of claim 1, wherein the at least one training recommendation model comprises an event model and a machine learning model.

3. The non-transitory computer-readable medium of claim 1, wherein the activity history comprises a ticket history associated with a ticket service.

4. The non-transitory computer-readable medium of claim 1, wherein the activity history comprises a workflow history associated with a workflow service.

5. The non-transitory computer-readable medium of claim 1, wherein the instructions, when executed by the at least one processor, cause the at least one computing device to at least:
receive, by the contextual training service, feedback data for the training recommendation or the training program.

6. The non-transitory computer-readable medium of claim 1, wherein the client device is associated with an administrator or a manager for the user account.

7. The non-transitory computer-readable medium of claim 1, wherein the client device is a personal device of a user described by the user account.

8. A system, comprising:
at least one computing device comprising at least one processor; and
a memory comprising machine-readable instructions, wherein the instructions, when executed by the at least one processor, cause the at least one computing device to at least:
identify, by a contextual training service, user context data for a user account, the user context data comprising identifications of: a user group, a user role, and at least one of: an activity history, a training history, a location history, and an email history;
input, by the contextual training service, the user context data into at least one training recommendation model;
generate, by the contextual training service, a training recommendation that recommends a training program that is mapped to the user context data by the at least one training recommendation model; and
surface, to a client device identified by the contextual training service, the training recommendation or the training program.

9. The system of claim 8, wherein the at least one training recommendation model comprises an event model and a machine learning model.

10. The system of claim 8, wherein the activity history comprises a ticket history associated with a ticket service.

11. The system of claim 8, wherein the activity history comprises a workflow history associated with a workflow service.

12. The system of claim 8, wherein the instructions, when executed by the at least one processor, cause the at least one computing device to at least:
receive, by the contextual training service, feedback data for the training recommendation or the training program.

13. The system of claim 8, wherein the client device is associated with an administrator or a manager for the user account.

14. The system of claim 8, wherein the client device is a personal device of a user described by the user account.

15. A method comprising:
identifying, by a contextual training service, user context data for a user account, the user context data comprising identifications of: a user group, a user role, and at least one of: an activity history, a training history, a location history, and an email history;
inputting, by the contextual training service, the user context data into at least one training recommendation model;
generating, by the contextual training service, a training recommendation that recommends a training program that is mapped to the user context data by the at least one training recommendation model; and
surfacing, to a client device identified by the contextual training service, the training recommendation or the training program.

16. The method of claim 15, wherein the at least one training recommendation model comprises an event model and a machine learning model.

17. The method of claim 15, wherein the activity history comprises a ticket history associated with a ticket service.

18. The method of claim 15, wherein the activity history comprises a workflow history associated with a workflow service.

19. The method of claim 15, further comprising:
receiving, by the contextual training service, feedback data for the training recommendation or the training program.

20. The method of claim 15, wherein the client device is associated with an administrator or a manager for the user account.
